(19) United States
(12) Patent Application Publication
(10) Pub. No.: US 2009/0274945 A1
(43) Pub. Date: Nov. 5, 2009

(54) Fuel Cell and Manufacturing Method of the Same

(75) Inventor: Yasuhiro Izawa, Mishima-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 11/992,135

(22) PCT Filed: Sep. 26, 2006
(86) PCT No.: PCT/JP2006/319640

§ 371 Date: Mar. 17, 2008

(30) Foreign Application Priority Data
Oct. 6, 2005 (JP) 2005-293290

(51) Int. Cl. H01M 2/02; H01M 4/82

(52) U.S. Cl. 429/34; 29/623.1

(57) ABSTRACT

A fuel cell includes an electrical power generator that has an electrolyte, a first electrode provided on one face of the electrolyte, and a second electrode provided on the other face of the electrolyte, a conductive frame that has an electrical potential substantially same as that of the first electrode and strengthens the electrical power generator, a power collector provided on the second electrode on the opposite side of the electrolyte, and an insulating member provided between the power collector and the conductive frame. In the fuel cell, it is restrained that the power collector contacts with the conductive frame. Therefore, an electrical short between the first electrode and the second electrode is restrained.

### TECHNICAL FIELD

This invention generally relates to a fuel cell and a manufacturing method of the fuel cell.

### BACKGROUND ART

In general, a fuel cell is a device that obtains electrical power from fuel, hydrogen and oxygen. The fuel cell is being widely developed as an energy supply system because the fuel cell is environmentally superior and can achieve high energy efficiency. The fuel cell has an electrical power generator in which electrodes hold an electrolyte therebetween with reference to Patent Document 1. And the fuel cell has a power collector for collecting an electrical power generated in the electrical power generator.

### Patent Document 1: Japanese Patent Application Publication No. 2004-146337

### DISCLOSURE OF THE INVENTION

### Problems to be Solved by the Invention

In the structure, a frame for strengthening the electrical power generator is necessary in order to reduce a thickness of the electrical power generator. It is possible that the electrodes are electrically conducted to each other, when the frame is conductive, the frame contacts with either of the electrodes, and an electrical potential of the frame is same as that of the electrode.

An object of the present invention is to provide a fuel cell restraining an electrical short between the electrodes and a manufacturing method of the fuel cell.

### Means for Solving the Problems

A fuel cell in accordance with the present invention is characterized by including an electrical power generator, a conductive frame, a power collector, and an insulating member. The electrical power generator has an electrolyte, a first electrode provided on one face of the electrolyte, and a second electrode provided on the other face of the electrolyte. The conductive frame has an electrical potential substantially same as that of the first electrode and strengthens the electrical power generator. The power collector is provided on the second electrode on the opposite side of the electrolyte. The insulating member is provided between the power collector and the conductive frame. In the fuel cell in accordance with the present invention, it is restrained that the power collector contacts with the conductive frame, because the insulating member is provided between the power collector and the conductive frame. And the electrical short between the first electrode and the second electrode is restrained. It is therefore possible to restrain a loss of power generation of the fuel cell in accordance with the present invention.

The insulating member may be provided between the second electrode and the conductive frame. In this case, it is restrained that the second electrode and the power collector contact with the conductive frame. Therefore, it is restrained that the first electrode is electrically conducted to the second electrode. The conductive frame may have a recess and a base. The electrical power generator may be provided in the recess.

A sum of a thickness of the recess and a thickness of the electrical power generator may be smaller than a thickness of the base. In this case, an upper face of the second electrode is positioned lower than an upper face of the base. And the insulating member fixes a side face of a lower portion of the power collector. A displacement of the power collector is therefore restrained. Accordingly, it is possible to restrain a contact between the power collector and the frame.

The first electrode may be an anode. The anode may be composed of a hydrogen permeable metal. The electrolyte may have proton conductivity. In this case, the conductive frame strengthens the hydrogen permeable membrane and the electrolyte. It is therefore possible to reduce the thickness of the hydrogen permeable membrane and the electrolyte. And it is possible to reduce a manufacturing cost of the fuel cell in accordance with the present invention.

A manufacturing method of a fuel cell in accordance with the present invention is characterized by including providing a first electrode and an electrolyte on a conductive frame, arranging an insulating member on a peripheral area of an upper face of the electrolyte, and providing a second electrode and a power collector on the electrolyte. With the manufacturing method in accordance with the present invention, the first electrode and the electrolyte are provided on the conductive frame, the insulating member is arranged on the peripheral area of the upper face of the electrolyte, and the second electrode and the power collector are provided on the electrolyte. In this case, the insulating member restrains that the conductive frame contacts with the power collector and the second electrode. Therefore, it is restrained that the first electrode is electrically conducted to the second electrode. Accordingly, a loss of power generation of the fuel cell is restrained. And it is not necessary to joint the conductive frame to the insulating member, because the insulating member is arranged after the first electrode and the electrolyte are provided. It is therefore possible to shorten the process.

Another manufacturing method of a fuel cell in accordance with the present invention is characterized by including providing a first electrode on a conductive frame, arranging an insulating member on a peripheral area of an upper face of the first electrode, and providing an electrolyte, a second electrode and a power collector on the first electrode in order. With the manufacturing method, the first electrode is provided on the conductive frame. The insulating member is arranged on the peripheral area of the upper face of the first electrode. The electrolyte, the second electrode and the power collector are provided on the first electrode in order. In this case, the insulating member restrains that the conductive frame contacts with the electrolyte, the power collector and the second electrode. It is restrained that the first electrode is electrically conducted to the second electrode. Accordingly, a loss of power generation of the fuel cell is restrained. And it is not necessary to joint the conductive frame to the insulating member, because the insulating member is arranged after the first electrode and the electrolyte are provided. It is therefore possible to shorten the process. The first electrode may be an anode. The anode may be composed of a hydrogen permeable metal. The electrolyte may have proton conductivity.

### EFFECTS OF THE INVENTION

According to the present invention, it is restrained that the power collector contacts with the conductive frame. It is therefore restrained that the first electrode is electrically conducted to the second electrode. Accordingly, a loss of power generation of the fuel cell in accordance with the present invention is restrained.

### BRIEF DESCRIPTION OF THE DRAWINGS

FIG. 1A and FIG. 1B illustrate a fuel cell in accordance with a first embodiment of the present invention;

FIG. 2A through FIG. 2F illustrate a process flow of a manufacturing method of a fuel cell;

FIG. 3A and FIG. 3B illustrate another manufacturing method of a fuel cell;

FIG. 4 illustrates a schematic cross sectional view of a fuel cell in accordance with a second embodiment of the present invention; and

FIG. 5 illustrates a schematic cross sectional view of a fuel cell in accordance with a third embodiment of the present invention.

### BEST MODES FOR CARRYING OUT THE INVENTION

A description will be given of best modes for carrying out the present invention.

### First Embodiment

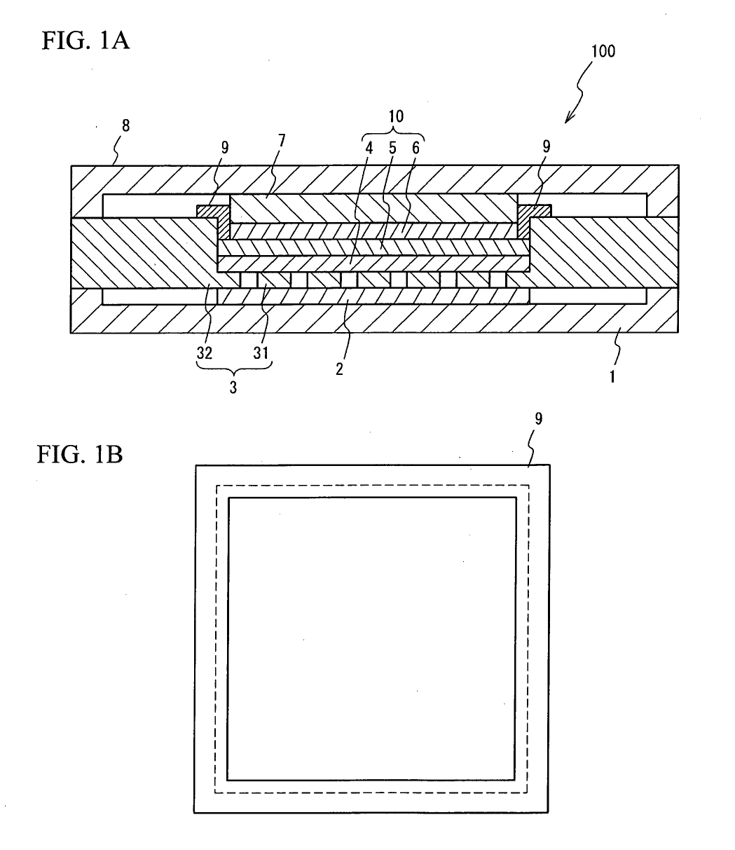

FIG. 1A and FIG. 1B illustrate a fuel cell 100 in accordance with a first embodiment of the present invention. FIG. 1A illustrates a schematic cross sectional view of the fuel cell 100. FIG. 1B illustrates a top view of an insulating member 9. In the first embodiment, a hydrogen permeable membrane fuel cell is used as a fuel cell. Here, the hydrogen permeable membrane fuel cell has a hydrogen permeable membrane. The hydrogen permeable membrane is composed of a metal having hydrogen permeability. The hydrogen permeable membrane fuel cell has a structure in which a solid electrolyte having proton conductivity is deposited on the hydrogen permeable membrane. Some hydrogen provided to an anode is converted into protons with catalyst reaction. The protons are conducted in the electrolyte having proton conductivity, react with oxygen provided to a cathode, and converted into water. Electrical power is thus generated. A description will be given of a structure of the fuel cell 100.

As shown in FIG. 1A, the fuel cell 100 has separators 1 and 8, power collectors 2 and 7, a frame 3, an electrical power generator 10 and the insulating member 9. The electrical power generator 10 has a hydrogen permeable membrane 4, an electrolyte 5 and a cathode 6. The separator 1 is composed of a conductive material such as stainless steal. And a convex portion is formed at a peripheral area on an upper face of the separator 1. The power collector 2 is, for example, composed of a conductive material such as a SUS430 porous material, a Ni porous material, a Pt-coated Al₂O₃ porous material, or a Pt mesh. The power collector 2 is laminated on a center area of the separator 1.

The frame 3 is composed of a conductive material such as stainless steal and strengthens the hydrogen permeable membrane 4 and the electrolyte 5. The frame 3 is formed on the separator 1 through the convex portion of the separator 1 and the power collector 2. The frame 3 is jointed to the separator 1. A recess is formed at a center area of an upper face of the frame 3. The hydrogen permeable membrane 4 and the electrolyte 5 are implanted in the recess. The recess is hereinafter referred to as a recess 31. A part of the frame 3 other than the recess 31 is referred to as a base 32. A plurality of holes is formed in the recess 31.

The hydrogen permeable membrane 4 acts as an anode to which fuel gas is provided, and is composed of a hydrogen permeable metal. A metal composing the hydrogen permeable membrane 4 is such as palladium, vanadium, titanium, tantalum or the like. An electrical potential of the frame 3 is substantially same as that of the hydrogen permeable membrane 4, because the hydrogen permeable membrane 4 is formed on the recess 31. Here, “substantially same electrical potential” means a case where a contact resistance is not considered. Therefore, the electrical potential of the frame 3 is substantially same as that of the hydrogen permeable membrane 4, even if an electrical differential is generated between the frame 3 and the hydrogen permeable membrane 4 because of the contact resistance. The electrolyte 5 is laminated on the hydrogen permeable membrane 4. The electrolyte 5 is, for example, composed of a proton conductor such as a perovskite-type proton conductor (BaCeO₃ or the like), a solid acid proton conductor (CsHSO₄ or the like).

The insulating member 9 is composed of ceramics such as alumina or zirconia, and is formed on an area from a peripheral area of an upper face of the electrolyte 5 to an upper face of the base 32. Therefore, the insulating member 9 has a shape so as to surround a peripheral area of an upper face of the electrical power generator 10, as shown in FIG. 1B. For example, a part of the insulating member 9 on the base 32 has a width of approximately 0.5 mm and has a thickness of 0.2 mm. A part of the insulating member 9 on the electrolyte 5 has a width of 1.0 mm. And the cathode 6 is, for example, composed of a conductive material such as lanthanum cobaltite, lanthanum manganate, silver, platinum, or platinum-supported carbon, and is laminated on the electrolyte 5.

The power collector 7 is composed of a material same as that of the power collector 2, and is laminated on the cathode 6. The power collector 7 has a thickness of approximately 0.5 mm to 0.8 mm. The separator 8 is composed of a conductive material such as stainless steal, and is laminated on the power collector 7. And a convex portion is formed at a peripheral area of a lower face of the separator 8. The separator 8 is jointed to the frame 3 through the convex portion of the separator 8. A joint face between the separator 8 and the frame 3 is subjected to an insulating treatment. Therefore, the separator 8 is electrically insulated from the frame 3. A plurality of the fuel cells 100 in accordance with the embodiment is laminated in an actual fuel cell.

Next, a description will be given of an operation of the fuel cell 100. A fuel gas including hydrogen is provided to a gas passageway of the separator 1. This fuel gas is provided to the hydrogen permeable membrane 4 via the power collector 2 and the through holes of the recess 31. Some hydrogen in the fuel gas is converted into protons at the hydrogen permeable membrane 4. The protons are conducted in the electrolyte 5 and get to the cathode 6.

On the other hand, an oxidant gas including oxygen is provided to a gas passageway of the separator 8. This oxidant gas is provided to the cathode 6 via the power collector 7. The protons react with oxygen in the oxidant gas provided to the cathode 6. Water and electrical power are thus generated. The generated electrical power is collected via the power collectors 2 and 7 and the separators 1 and 8.

In the embodiment, it is restrained that the cathode 6 and the power collector 7 are electrically conducted to the frame 3, because the insulating member 9 is provided between the cathode 6 and the frame 3 and between the power collector 7 and the frame 3. Therefore, an electrical short between the hydrogen permeable membrane 4 and the cathode 6 is restrained. And it is restrained that the power collector 7 contacts with the frame 3 even if the power collector 7 moves, because the insulating member 9 extends to the upper face of the base 32. It is therefore possible to restrain a loss of power generation of the fuel cell 100. Further, it is restrained that the cathode 6 is electrically conducted to the frame 3, even if the cathode 6 and the power collector 7 are formed on whole area of the upper face of the electrolyte 5. It is therefore possible to enlarge power generation efficiency at a maximum without an electrical short between the hydrogen permeable membrane 4 and the cathode 6.

It is possible to restrain the electrical short when an insulating layer is provided on the frame 3. In this case, however, there may be generated a problem such as a separation at the frame 3. In the embodiment, it is possible to restrain the electrical short with a simple structure in which the insulating member 9 is provided on the electrolyte 5. Therefore, there is not generated the separation at the frame 3. The insulating member 9 may be provided on an area from a peripheral area of an upper face of the hydrogen permeable membrane 4 to the upper face of the base 32. In this case, the electrolyte 5 may not act as an insulating member. And it is possible to restrain a contact between the cathode 6 and the frame 3 and between the power collector 7 and the frame 3.

The insulating member 9 may be provided on an area from the peripheral area of the upper face of the hydrogen permeable membrane 4 or the electrolyte 5 to whole area on the base 32. In this case, it is possible to restrain the electrical short between the cathode 6 and the frame 3 and between the power collector 7 and the frame 3. The insulating member 9 may have any shape if the insulating member 9 is provided between the cathode 6 and the frame 3 and between the power collector 7 and the frame 3. The insulating member 9 may have any shape according to the shape of the electrical power generator 10, although the insulating member 9 has a rectangular frame shape in the embodiment.

It is preferable that the base 32 has a thickness more than a sum of the thickness of the recess 31 and the thickness of the electrical power generator 10. That is, it is preferable that an upper face of the cathode 6 is positioned lower than that of the base 32. In this case, the insulating member 9 fixes a side face of the lower portion of the power collector 7. A displacement of the power collector 7 is therefore restrained. As a result, it is possible to restrain the contact between the power collector 7 and the frame 3. And it is possible to reduce the thickness of the hydrogen permeable membrane 4 and the electrolyte 5, because the frame 3 strengthens the hydrogen permeable membrane 4 and the electrolyte 5. It is therefore possible to reduce a cost of manufacturing the fuel cell 100 in accordance with the embodiment.

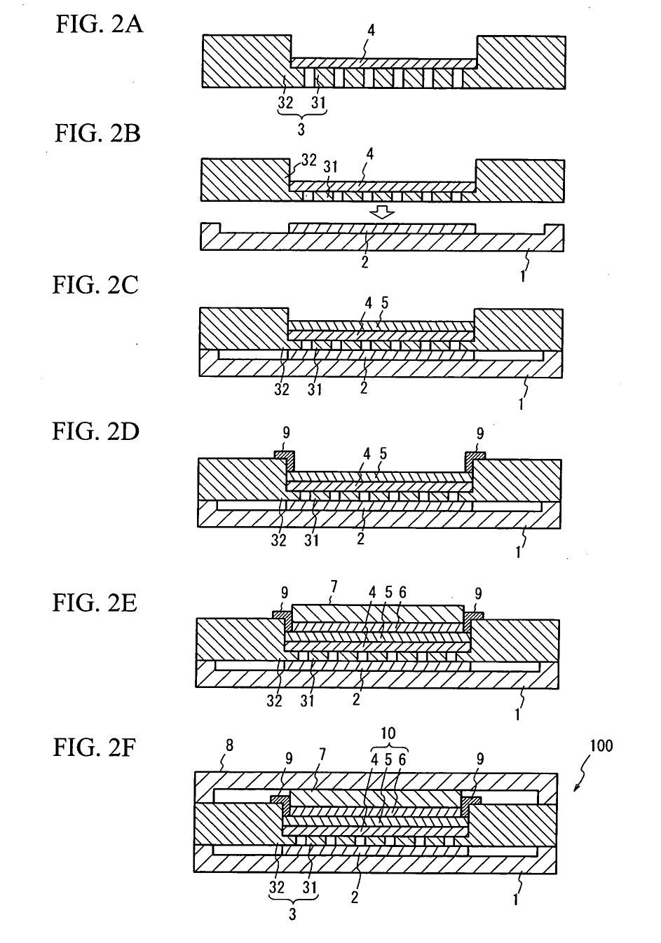

Next, a description will be given of a manufacturing method of the fuel cell 100. FIG. 2A through FIG. 2F illustrate a process flow of the manufacturing method of the fuel cell 100. As shown in FIG. 2A, the hydrogen permeable membrane 4 is provided on the recess 31 of the frame 3. Next, as shown in FIG. 2B, the power collector 2 is provided on the separator 1 and the separator 1 is jointed to the frame 3.

Then, as shown in FIG. 2C, the electrolyte 5 is formed on the hydrogen permeable membrane 4. Next, as shown in FIG. 2D, the insulating member 9 formed in advance is implanted in the recess 31. That is, the insulating member 9 is arranged on the peripheral area of the upper face of the electrolyte 5. Then, as shown in FIG. 2E, the cathode 6 and the power collector 7 are provided on the electrolyte 5. Next, as shown in FIG. 2F, the separator 8 is provided on the frame 3 and on the power collector 7, and the frame 3 is jointed to the separator 8. With the above process, the fuel cell 100 is manufactured.

With the manufacturing method of the fuel cell 100 in accordance with the embodiment, it is possible to restrain the electrical short by simply implanting the insulating member formed in advance to the recess 31 of the frame 3. It is not necessary to joint the frame 3 to the insulating member 9, because the insulating member 9 is implanted in the recess 31 after the hydrogen permeable membrane 4 and the electrolyte 5 are provided in the recess 31. It is therefore possible to shorten the process.

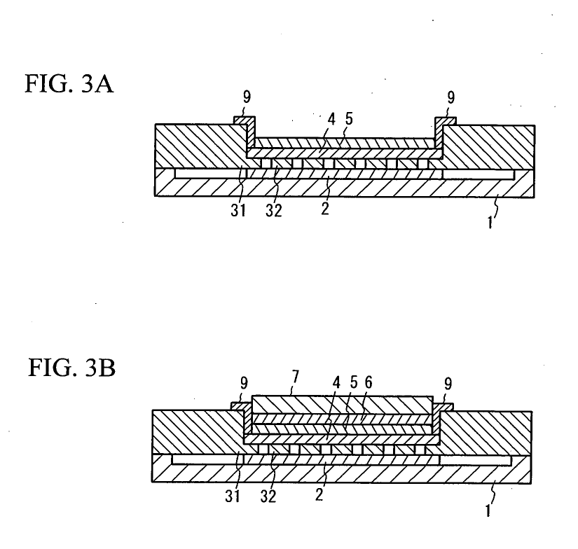

It is restrained that there is generated a problem such as a defective joint between a metal and a ceramics, because it is not necessary to joint the frame 3 to the insulating member 9. The joint strength may be reduced even if the frame 3 is jointed to the insulating member 9. Therefore, the present invention has an advantage in cost. The insulating member 9 may be implanted in the recess 31 before forming the electrolyte 5. In this case, as shown in FIG. 3A and FIG. 3B, it is possible to restrain the contact between the cathode 6 and the frame 3 more effectively. In the first embodiment, the hydrogen permeable membrane 4 corresponds to the first electrode; the cathode 6 corresponds to the second electrode; and the frame 3 corresponds to the conductive frame.

### Second Embodiment

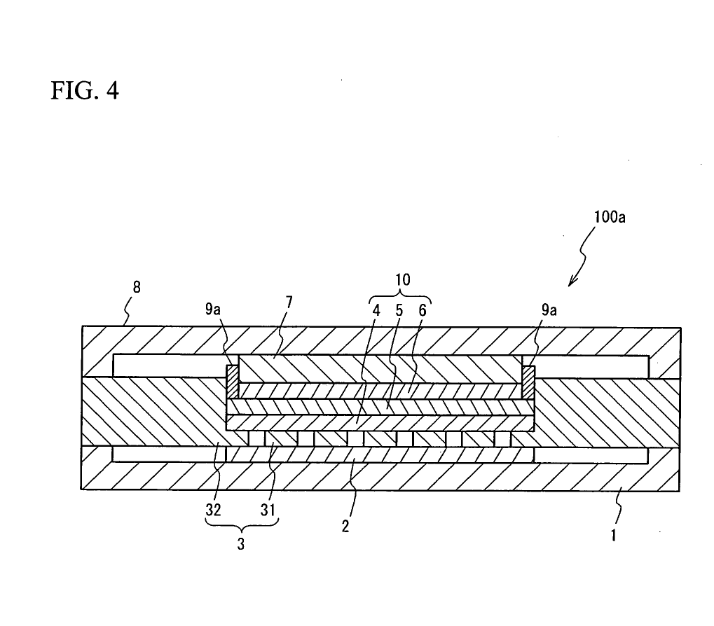

Next, a description will be given of a fuel cell 100a in accordance with a second embodiment of the present invention. FIG. 4 illustrates a schematic cross sectional view of the fuel cell 100a. In the fuel cell 100a, an insulating member 9a is provided instead of the insulating member 9. In other points, the fuel cell 100a has a same structure as the fuel cell 100. The same components as those shown in the first embodiment have the same reference numerals in order to avoid a duplicated explanation.

The insulating member 9a is composed of an insulating material such as ceramics, and is provided on an area from the peripheral area of the upper face of the electrolyte 5 to a position above the base 32. Therefore, the insulating member 9a has a shape surrounding the peripheral area of the upper face of the electrolyte 5. For example, the insulating member 9a has a thickness of approximately 1.0 mm.

In the embodiment, it is restrained that the hydrogen permeable membrane 4 is electrically conducted to the cathode 6, because the insulating member 9a is provided between the cathode 6 and the frame 3 and between the power collector 7 and the frame 3. And the insulating member 9a fixes the power collector 7, because the insulating member 9a extends to above the upper face of the base 32. It is therefore possible to restrain the contact between the power collector 7 and the frame 3. It is therefore possible to restrain a loss of power generation of the fuel cell 100a. It is not necessary to form the insulating member 9a on the upper face of the base 32 as is the case of the first embodiment.

The insulating member 9a may be provided on an area from the peripheral area of the hydrogen permeable membrane 4 to the position above the base 32. In this case, it is possible to restrain the electrical short between the cathode 6 and the frame 3 and between the power collector 7 and the frame 3. It is preferable that the base 32 has a thickness more than the sum of the thickness of the recess 31 and the thickness of the electrical power generator 10, similarly to the first embodiment.

### Third Embodiment

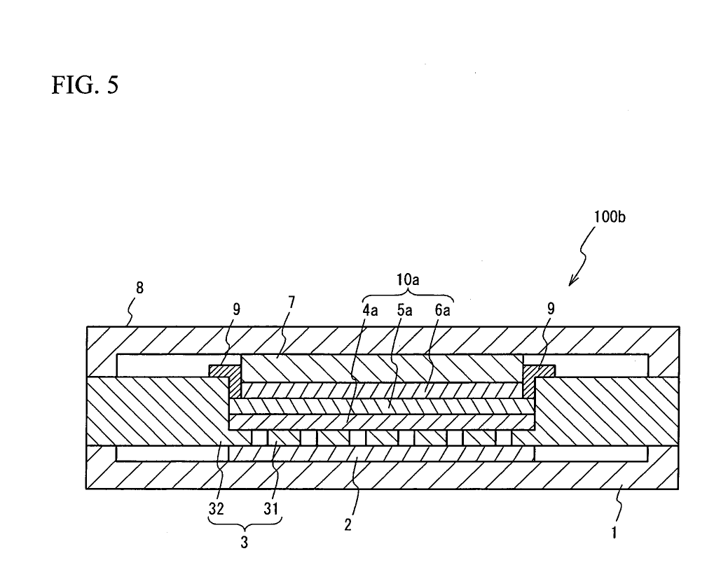

Next, a description will be given of a fuel cell 100b in accordance with a third embodiment of the present invention. In the embodiment, a solid oxide fuel cell is used as a fuel cell. FIG. 5 illustrates a schematic cross sectional view of the fuel cell 100b. In the fuel cell 100b, an anode 4a is provided instead of the hydrogen permeable membrane 4; an electrolyte 5a is provided instead of the electrolyte 5; and a cathode 6a is provided instead of the cathode 6. In other points, the fuel cell 100b has a same structure as the fuel cell 100 shown in FIG. 1A and FIG. 1B. The same components as those shown in the first embodiment have the same reference numerals in order to avoid a duplicated explanation.

The anode 4a is an electrode composed of such as nickel cermet. The electrolyte 5a is an electrolyte composed of a proton conductive material such as LaGaO₃-based oxide. The cathode 6a is an electrode composed of such as La_{0.6}Sr_{0.5}CoO₃.

In the embodiment, it is restrained that the anode 4a is electrically conducted to the cathode 6a, because the insulating member 9 is provided between the cathode 6a and the frame 3 and between the power collector 7 and the frame 3. It is therefore possible to restrain a loss of power generation of the fuel cell 100b. The insulating member 9 may be provided on an area from a peripheral area of an upper face of the anode 4a to the position above the base 32. It is preferable that the base 32 has a thickness more than the sum of the thickness of the recess 31 and the thickness of the electrical power generator 10, similarly to the first embodiment.

In the embodiments mentioned above, the electrical power generator is provided in the recess of the frame. However, it is not limited to the structure. For example, the electrical power generator may be provided on a plane frame. In this case, the effect of the present invention is obtained when the insulating member is formed so as to surround the electrical power generator on the frame. The insulating member 9a in accordance with the second embodiment may be applied to the first embodiment and the third embodiment. The insulating member 9 in accordance with the first embodiment may be applied to the second embodiment.

The present invention may be applied to other fuel cells having a conductive frame strengthening an electrolyte, although the hydrogen permeable membrane fuel cell and the solid oxide fuel cell are used as a fuel cell in the above embodiments. For example, it may not be possible to use a polymer member as the frame in a fuel cell operating in an intermediate temperature range more than 300 degrees C. In this case, the present invention is effective in particular, because a metal such as stainless steal is used as the frame.

In the third embodiment, the anode 4a corresponds to the first electrode; and the cathode 6a corresponds to the second electrode.

The electrical potential of the frame may be substantially same as that of the cathode and the insulating member may insulate the frame from the power collector on the hydrogen permeable membrane, although the electrical potential of the frame is substantially same as that of the hydrogen permeable membrane and the insulating member insulates the frame from the power collector on the cathode in the above embodiments.

1. A fuel cell comprising:
an electrical power generator that has an electrolyte, a first electrode provided on one face of the electrolyte, and a second electrode provided on the other face of the electrolyte;
a conductive frame that has an electrical potential substantially same as that of the first electrode and strengthens the electrical power generator;
a power collector provided on the second electrode on the opposite side of the electrolyte; and
an insulating member provided between the power collector and the conductive frame.

2. The fuel cell as claimed in claim 1, wherein the insulating member is provided between the second electrode and the conductive frame.

3. The fuel cell as claimed in claim 1, wherein:
the conductive frame has a recess and a base; and
the electrical power generator is provided in the recess.

4. The fuel cell as claimed in claim 3, wherein a sum of a thickness of the recess and a thickness of the electrical power generator is smaller than a thickness of the base.

5. The fuel cell as claimed in claim 1, wherein the first electrode is an anode.

6. The fuel cell as claimed in claim 5, wherein:
the anode is composed of a hydrogen permeable metal; and
the electrolyte has proton conductivity.

7. A manufacturing method of a fuel cell comprising:
providing a first electrode and an electrolyte on a conductive frame;
arranging an insulating member on a peripheral area of an upper face of the electrolyte; and
providing a second electrode and a power collector on the electrolyte.

8. A manufacturing method of a fuel cell comprising:
providing a first electrode on a conductive frame;
arranging an insulating member on a peripheral area of an upper face of the first electrode; and
providing an electrolyte, a second electrode and a power collector on the first electrode in order.

9. The method as claimed in claim 7, wherein the first electrode is an anode.

10. The method as claimed in claim 9, wherein:
the anode is composed of a hydrogen permeable metal; and
the electrolyte has proton conductivity.

11. The fuel cell as claimed in claim 3, wherein the first electrode is an anode.
